(19) United States
(12) Patent Application Publication
(10) Pub. No.: US 2019/0304001 A1
(43) Pub. Date: Oct. 3, 2019

(54) Figurator

(71) Applicant: PATRICK JACQUES ANDRE MARIE DANEY DE MARCILLAC, Gieres (FR)

(72) Inventor: PATRICK JACQUES ANDRE MARIE DANEY DE MARCILLAC, Gieres (FR)

(21) Appl. No.: 16/385,007

(22) Filed: Apr. 16, 2019

(51) Int. Cl. G06Q 30/06

(52) U.S. Cl. CPC G06Q 30/0631; G06Q 30/0641; G06Q 30/0603

(57) ABSTRACT

As products and services architectures increasingly use a modular approach, the use of configurators needed to assemble bundles increases correspondingly

Situation: Configurators are typically focused on creating one bundle at a time. Each bundle is made of various parts selected from a given catalog in a way that they all work together. Configurators help customer visualize the bundle obtained and understand its characteristics (For example pricing, weight, consumption, shipping cost . . . )

Complication: There are situations where customers may want to combine in different ways (use-cases) two (or more) parts from one (or several) configured bundles. In such a case they may have to try various bundle configurations to visualize possible resulting use-cases. As the number of parts increases per bundle and the number of bundles increases, the combination of possible use-cases increases even more. Figuring out use-case from bundles becomes a lengthy task.

Solution: Present at once (variant=in a guided way) customers with all possible (variant=some) use-cases based on all (variant=some or one) bundles already configured

### SUMMARY OF THE “FIGURATOR” INVENTION

A system helping customers figure out possible use-cases derived from combining components from one or more bundle(s) previously configured

### PROBLEMS SOLVED

Help customers figure out many use-cases from one or more configured bundles

### PRIOR SOLUTION

Use of comparators that present side by side product features for a limited set of products
   does not offer a comprehensive overview or all possible combinations
Use of filters that bring several items all matching selected criteria
   while various components may be shown on a page, they are not combined in visual use-cases
Mailing documents that apply a set of characteristics from a given list into a template
   applies only combinations that have been thought of by the user up-front but doesn't suggest more nor all combinations

### DESCRIPTION

Like the “1-click” process patented by a large online provider made customer shopping experience more effortless, the “zero click figurator” (Variant 1: “guided figurator”) will reduce users' effort by visualizing all (Variant 1: Some) use-cases enabled by all (Variant 1: “some or one”) bundles that they just configured (variant 2: while respecting association rules).

Variant 2: The system may offer the administrator the opportunity to configure rules for how the various parts may and/or may not be combined by the “figurator” or “guided figurator”—of which possibly adding one or more customer provided objects in the mix

Example that has been Demonstrated Adding to a Standard Configurator on Dec. 14, 2018:

In the example below which has been applied to the fashion industry, a user wants to purchase a set of cloths from a given catalog that matches well together while the merchant offers bundles at a reduced price to increase its sell out:
The catalog is made of 4 tops and 2 bottoms each coming in 4 colors and various sizes
The merchant offers bundles of 6 tops and 4 bottoms both at a reduced price
Based on the customer selection (Several clicks), a configurator will present the corresponding 2 bundles

But the customer is not sure if all the tops fit nicely with all the bottoms and may hesitate to purchase

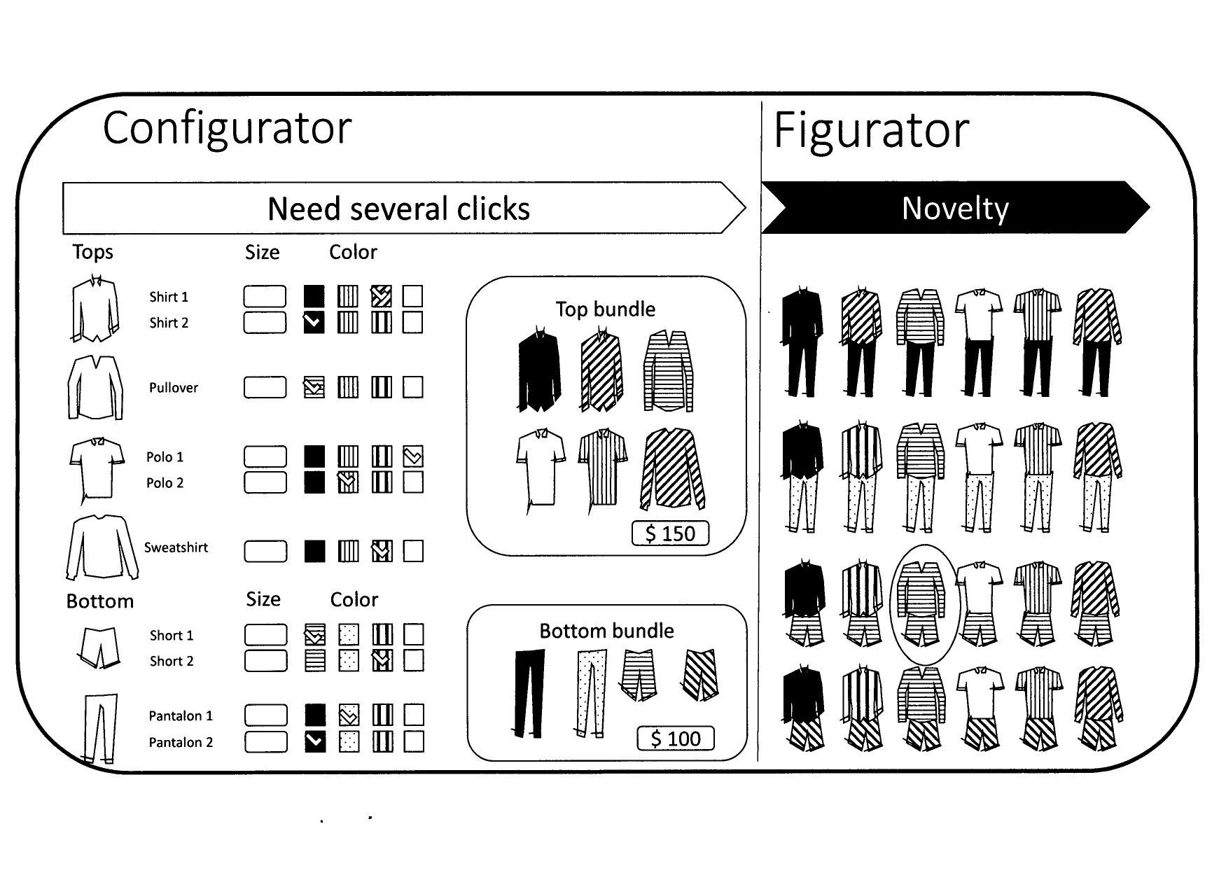

When the “figurator” process is applied, all possible combinations of use-cases are shown automatically (i.e. zero click), or in a guided variant (not “zero click” per say i.e. upon user's action, or gradually after customer's further directions) as illustrated in FIG. 1.

User may then easily figure out that one or more use-case is not to his/her liking (like the grey/grey combination circled out in FIG. 1) and may change the configuration accordingly until the resulting use-cases compel him/her to buy the bundles.

### Complexity Solved:

There are 6 types of cloths coming in 4 colors each which together are constituting a catalog of 6×4=24 items
The top bundle can be assembled in 6\hat{ }4=1,296 ways respectively the bottoms in 4\hat{ }4=256 ways resulting in 1,296×256=331,776 possible shopping cart combinations
Each of them resulting in 24 use-cases that would be available to the buyer amongst a universe made of 4 top types in 4 colors or 16 top items displayed over 8 bottom items or 128 use-cases
The “figurator” automatically displays the 24 use-cases that would be available to the user (out of the 128 possible ones), based on the two bundles he/she configured (out of the 331,776 possible combinations of unique couple of bundles)

### Variant 1=Guided “Figurator”:

Customer may be asked if they want to see the collar effect on the top or not,
And or how it would look like if tucking the tops into bottoms or not,
which would increase the number of use cases greatly
or how many use-cases to present at a time (if there were too many)

### Variant 2=Association Rules:

Here above the association rule was “any one top on any one bottom”.
But another rule could have been “any shirt or polo on any one bottom, then either nothing more or any pullover or any sweatshirt over the previously selected top” in which case the user would have seen various combinations of collar's color of the chosen tops under the sweatshirts and the pullovers.
Rules could have been set to tuck the polos into the trousers but not the trunks.
Or for the user to upload a photo such that his/her head would show behind each model, or his/her all body will appear as if dressed up in each model. Both exist as an add on to a given bundle but adding them to all use-case doesn't.

### ADVANTAGES

The figurator offers a comprehensive overview of many use-case combinations from one or mode bundles, either automatically or guided in steps based on customer rules' selection
As a variants customers may be guided, different rules may be set and it may be combined with one or more objects provided by customer outside of existing catalog of parts making the bundle(s)

1. Zero click figurator:
A system helping customers figure out automatically all possible use-cases derived from combining all components from one or more bundle(s)

2. Guided figurator:
A system helping customers figure out in guided steps several possible use-cases derived from combining several components from one or more bundle(s) thus triggering a larger universe of association possibilities and/or selecting the one shown

3.

4. Customized figurator:
A system helping customers figure out possible use-cases derived from combining components from one or more bundle(s) possibly adding one or more customer provided object(s) into the uses-case mix according to association rules that may be customized
